(19) United States
(12) Patent Application Publication
(10) Pub. No.: US 2005/0254447 A1
(43) Pub. Date: Nov. 17, 2005

(54) Domestic multimedia transmission method and system

(75) Inventor: Richard M. Miller-Smith, Lingfield (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/524,180

(22) PCT Filed: Jul. 29, 2003
(86) PCT No.: PCT/IB03/03354

§ 371 Date: Feb. 10, 2005

(51) Int. Cl. H04J 1/10; H04J 3/08; H04B 7/14

(52) U.S. Cl. 370/315

(57) ABSTRACT

There is provided transmission of MPEG2 audio and data over an in-house wireless network using the 802.11b standard with a Home Media Centre to tune and store a number of TV and audio streams for distribution to a number of client devices throughout a home. A transrater reduces the bit rate for use in the limited bandwidth wireless communications network. Prioritisation of the data packets for resending is made according to content format and/or age.

The present invention relates to a method for the streaming of data, to a system for the streaming of data, and to apparatus for the streaming of data.

U.S. Pat. No. 5,768,533 relates to encoding of video in segments which are transmitted independently. If an error occurs, the server re-encodes the band segment in an I-frame and transmits it again.

U.S. Pat. No. 6,025,888 discloses a system involving processing of data at the server to make the MPEG signals as robust as possible, based on determining the most important macroblocks and encoding them in an intra-fashion. Accordingly, the system results in a substantial increase in the MPEG signal size.

U.S. Patent Publication 2001/0019589 discloses processing AV data at the server to automatically set the amount of error resilience for a particular unit of video and hence changes the error correction settings of the transmitter.

An object of the present invention is to provide a method for the streaming of data for use with a limited bandwidth communications network.

The present invention provides a method for streaming of data with a limited bandwidth communications network, the method comprising reducing the bit rate stream using transrater means; prioritising the data packets for re-sending according to content format and/or age; re-sending the data packets according to the prioritisation.

Advantageously, the prioritisation step comprises one or more of the following steps:—
Defining the data packets according to content type, comprising audio data packets and video data packets;
Defining three video packet types comprising I-frames, P-frames, and B-frames;
Defining, for each data packet type, a weighting factor.

Preferably the weighting factor is multiplied by the “age” factor of a data packet, calculated by subtracting the sequence number of the missing packet from the sequence number of the most recent correctly received data packet such that

P=Wₓ(S−s), where P is the priority, Wₓ, is the weighting factor of the data packet type, S is the sequence number of the most recent correctly received packet and s is the sequence number of the missing data packet.

In this way, the present invention provides efficient and effective processing to reduce the bit rate; also valuable information about the video steam may be used to prioritise the order in which data packets are sent.

Preferably, the weighting factor Wₓ for the types of data packet are, in reducing order of importance,
(i) audio;
(ii) I-frames;
(iii) P-frames;
(iv) B-frames.

Preferably also, the method comprises re-sending the data packets with the highest value of P first and thereafter re-sending in sequence according to reducing values of P, with the lowest value of P last.

The method may include incrementing a resend timer when a new packet is received. If a missing packet is not received within an interval, as measured by this timer, from sending the original request, then a new request is sent. The method may further comprise incrementing the resend timer after a period of receiving no packets.

In this way, a risk of repeatedly requesting the same packet is greatly reduced thus reducing the amount of back traffic from the client to the server.

An alternative way of avoiding this problem is to restrict the sending of request packets such that these are only transmitted on a multiple of a timeout value, as measured by the resend timer.

The present invention is particularly suited to the methods of transmitting audio and video data using MPEG compression.

The present invention is also particularly suited to restricted bandwidth techniques involving wireless transmission, for example 802.11b (also called WiFi) networks.

The present invention is particularly suited to the transmission of MPEG2 audio and data over an in-house wireless network, with a Home Media Centre to tune to and store a number of TV and audio streams, and to distribute to a number of client devices throughout a home.

A significant advantage of the present invention over the acknowledged prior art is that it enables the use of wireless protocol optimised for MPEG audio and video.

Another advantage of the present invention is that it does not require MPEG streams to be parsed separately using extra CPU cycles.

Another aspect of the present invention provides a computer program product directly loadable into the internal memory of a digital computer, comprising software code portions for performing the steps the method of the present invention when said product is run on a computer.

Another aspect of the present invention provides computer program for performing the steps of the method of the present invention when said product is run on a computer.

A further aspect of the present invention provides electronic distribution of a computer program product or a computer according to a method of the present invention.

A further aspect of the present invention provides a system for streaming of data with a limited bandwidth communications network, the system comprising:
transrater means;
means to input data packets to the transrater means to reduce the bit rate stream;
means to prioritise missing data packets for re-sending according to content format and/or age;
means to re-send the missing data packets according to the prioritisation.

The system may include the additional features of the present invention as defined herein.

A further aspect of the present invention provides a system for streaming of data with a limited bandwidth communications network, the system comprising:
transrater means;
means to input data packets to the transrater means to reduce the bit rate stream;
means to prioritise missing data packets for re-sending according to content format and/or age;
means to re-send the missing data packets according to the prioritisation.

A further aspect of the present invention provides server means and/or client means incorporating features of the apparatus embodying the present invention.

In order that the invention may more readily be understood, a description is now given, by way of example only, reference being made to the accompanying drawings, in which:—

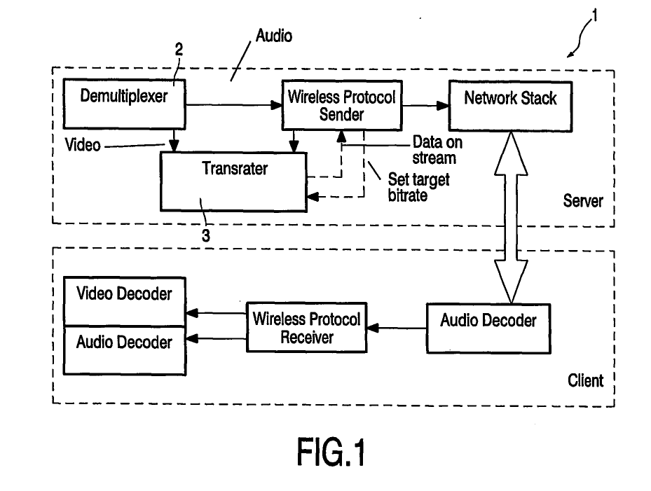

FIG. 1 is a general diagram of a system embodying the present invention;

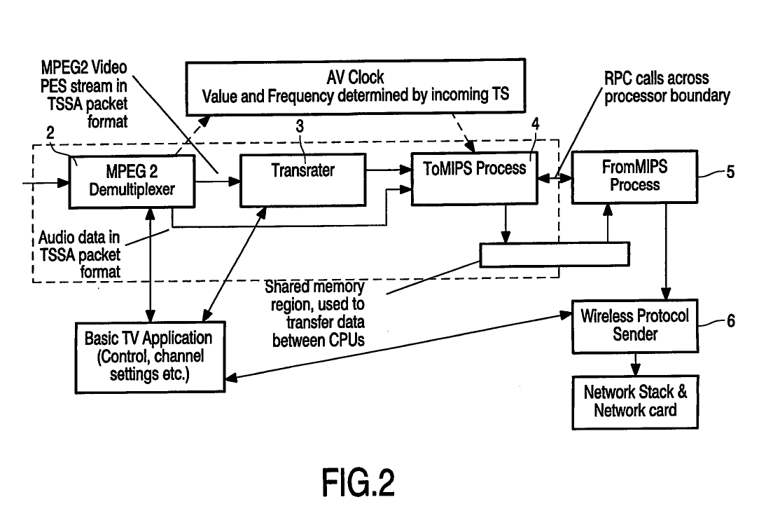

FIG. 2 is a more detailed block diagram of the system of FIG. 1;

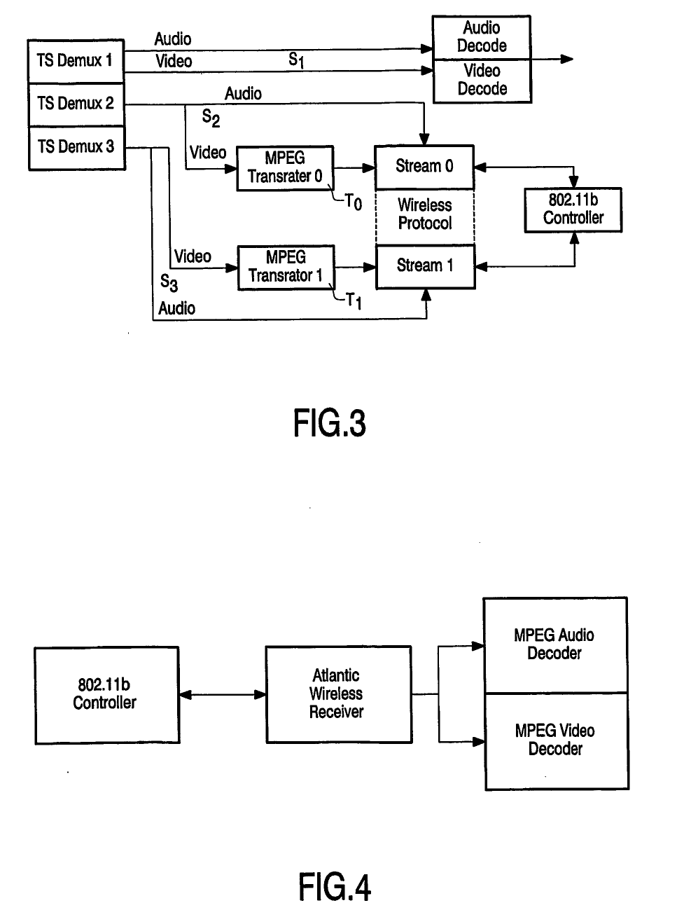

FIG. 3 shows a server of the system of FIG. 1;

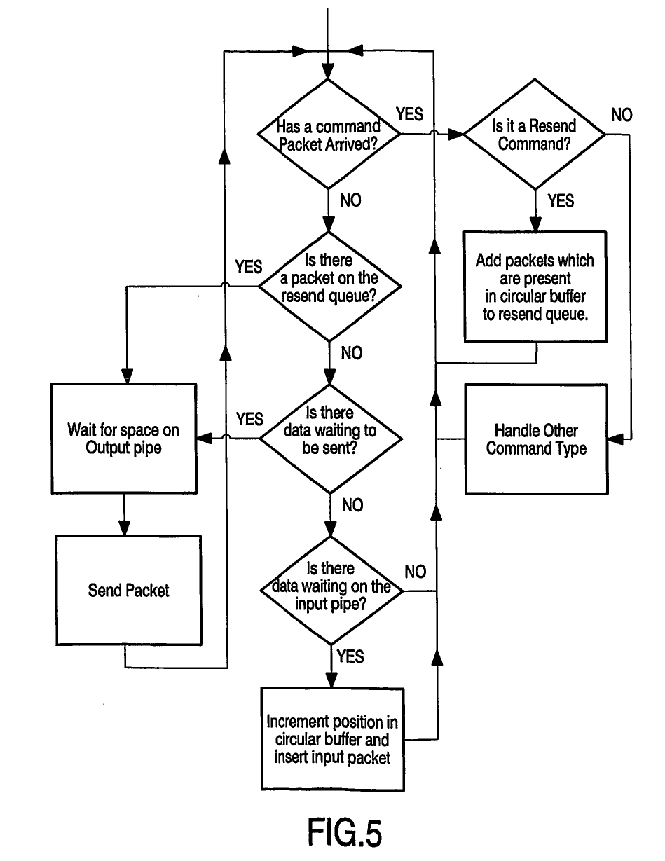

FIG. 4 shows a client of the system of FIG. 1;

FIG. 5 is a server state machine diagram of the system of FIG. 1; and

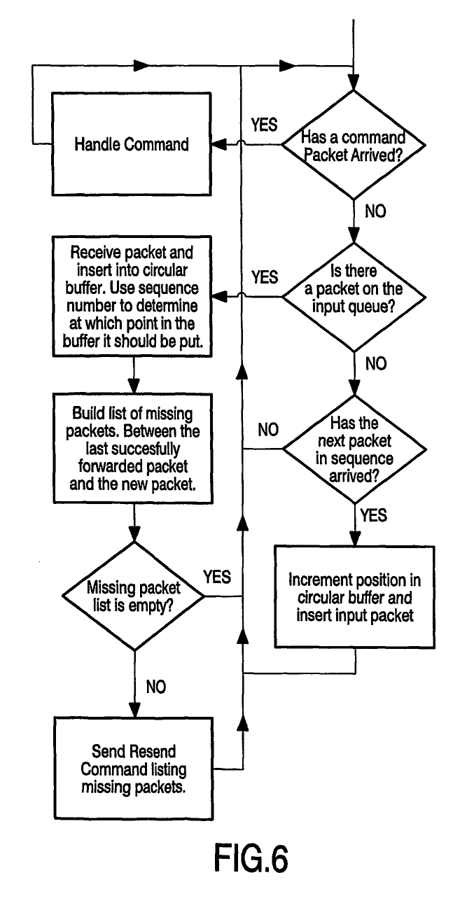

FIG. 6 is a client state machine diagram of the system of FIG. 1.

The system 1 as shown in FIG. 1 involves, audio and video streaming using MPEG2 compression standard, but it is applicable to other compression standards (e.g. MPEG4). Data is taken from a real time broadcast source, or off an optical or hard disk. It has a communications network with a limited bandwidth, in this example being is the 802.11b wireless network. It has a client device with the required AV decoders.

The system 1 has a transrater module which it inputs MPEG2 compliant video elementary stream, or packetised elementary stream. It outputs a MPEG2 compliant video elementary stream. The (average) bitrate of the output is capped at a certain level, the target bitrate (TBR). The target bitrate can be dynamically altered. The frame structure of the stream is not changed. The current transrater works below the slice level, reducing the quantity of data (e.g. reducing the number of non-zero DCT coefficients). As it parses the bitstream, it stores information detailing the structure of the stream.

Description of Current System

The current implementation of the system runs on a Philips Nexperia PNX8525 IC. This is a chip designed for adaptable, high end set-top boxes and similar systems. It is a dual CPU machine, it has a MIPS processor for overall system control and a TriMedia processor for media processing. However, the system can be easily adapted for a single CPU machine.

In the server of FIG. 2, the demultiplexer 2 takes in an MPEG2 transport stream from a tuner. This transport stream can conform to the DVB standard. The demultiplexer 2 is controlled, via an RPC mechanism, by a process running on the MIPS processor. The demultiplexer 2 uses the regular input of the transport stream to keep a clock running at 90 kHz and also outputs an audio and video stream. These streams are packetised in packets as defined by the TriMedia Software Streaming Architecture. The data is segmented, each segment creating a packet. Each packet is accompanied by some data, this data includes the packet length, timestamps, data type etc.

The transrater 3 takes a video stream, packetised in TSSA packets. It works on these packets such that the bitrate of the data contained in the output packets is limited to a set value. The output packets are also in TSSA packets. However, the output packets have additional data. This data is added by the transrater 3. This data includes the type of frame that the data held within the packet belongs to and the length of this frame.

The ToMips block 4 takes in one audio and one video TSSA stream. The data is extracted from these packets and formatted into the packet structure required for the wireless protocol. These packets have a header which describes the information held within the packet, this information being taken from the TSSA packets. A reading is also taken from the system clock to be inserted in each packet header. ToMIPS 4 writes this data into a memory region accessible to both processors. The ToMIPS 4 component works with the FromMIPS component 5 via RPC calls, in order to transfer the data.

The FromMIPS block 5 receives the data out of the shared memory region and passes it on to the protocol sender.

The wireless protocol sender 6 handles sending the data across the network connection, in this system being an 802.11b network.

The system 1 of the present invention incorporates software to transmit MPEG2 audio and video data over an in-home wireless network. This network incorporates a ‘Home Media Centre’ which has the capability to tune to and store TV streams. This system connects to a number of client devices around the home via a wireless network.

Using this network, the audio and video data is streamed to these clients.

This system has a server combined with a wireless in-home network, for example using a Philips Nexperia server (typically a PNX8525 server) with the capability to input three AV streams. One of these is displayed on the local server and the other two are transmitted to two Viper based client systems.

The system runs Linux on the MIPS processor in Viper and pSOS on the TriMedia.

Server Architecture

FIG. 3 shows a very simplified view of the server architecture having three transport stream inputs S₁, S₂, S₃ that demultiplex one or more incoming streams. S₁ is shown on a local TV display. The video information of the other two S₂, S₃ is processed in MPEG2 transraters T₀ and T₁ these units act on the MPEG2 stream such that it does not exceed a certain average bitrate, in order to limit the usage of the wireless stream by the video information.

The two transrated T₀ and T₁ streams are reunited with their audio as the data is streamed into the wireless protocol WP unit. This unit re-multiplexes data and transmits it using the Linux network libraries. It communicates with the client in order to achieve the most optimal data transmission.

Client Architecture

The client is a much simpler system, for example implemented on a Philips PNX8525 system. Alternatively however, it could also to ported be a basic TriMedia or a simpler Nexperia device.

The client runs the Altantic wireless protocol receiver. This acts to receive data from the server forwarding the information to the relevant decoders. The protocol aims to preserve the quality of the audio and video transmitted.

The system of the present invention utilises 802.11b standard communications technology and operates at up to 11 mbps bandwidth, although under reasonable conditions the maximum achievable bandwidth is about 6.5 mbps with transmitted packet size increased from the standard 1500 bytes. The range with maximum bitrate of the typical 802.11b standard network embodying the present invention is of the order of 23 meters from the server. The communications network uses acknowledgement packets to ensure good data transfer. Packets are transmitted by the sender and are accompanied by a checksum. This checksum is checked on the receiver; if it is correct, then an acknowledgement is sent back. If it is not correct, the packet is dropped. The emphasis is therefore on the sender to resend any packets. Most implementations will try and resend a packet limited number of times.

In the system of the present invention, the protocol is implemented in two parts. This is due to the dual CPU nature of the units. In the server, both the transport stream input and transrater are resident on the processor. Therefore, in order to stream the output of these across the network, it is necessary to forward the information to the MIPS system running Linux. Similarly, on the client, it is necessary to receive the data on the MIPS/Linux processor and forward it to the TriMedia decoder chain.

Server

On the server side, a module called ‘ToMips’ is implemented. This has two inputs; one receives video data out of the transrater, the other audio data. The ToMips component collates this data into packets of the size used across the network. It also fills in the packet header information, including a sample of the decoder clock on the server.

The data is transferred to a process, called ‘CopyPacketsTMtoMIPS’, which runs on the MIPS. The standard TMMAN RPC calls are used to achieve this transfer. This process, in turn, forwards the information it has gained to a Unix pipe. The actual protocol handling process reads this information out of this pipe.

Client

The client protocol handler feeds the packets it receives into a Unix pipe. This is emptied by a ‘CopyPacketsMIPStoTM’ which uses TMMAN calls to forward packets to the ‘FromTM’ task on the TriMedia. This task demultiplexes the data and forwards the data to the audio and video decoders.

The software protocol provides a resilient connection, optimised for the transmission of audio and video data, between two systems.

The protocol is built on top of UDP.

The system uses the Linux IP network stack with changes to three settings, namely:
Send Buffer Size: The size of the transmission buffer for a socket.
Receive Buffer Size: The size of the receive buffer for a socket.
Type of Service (TOS): These are special bits, defined by the IP standard which fit in the IP header. They define the type, or ‘importance’ of the packets sent by the socket. Linux uses the setting in these packets to prioritise the order in which it sends packets. The allowable settings for this field are:
   Low Delay: Send as soon as possible
   Throughput: Attempt to maximise throughput
   Reliability
   Minimum Cost: Lowest level of priority.

The server transmits the data, encapsulated in packets, to the client by sending it, in order, through a UDP socket targeted at an open UDP socket on the client. This connection is initialised and mediated by an open, connected TCP link between the two systems. This is the ‘Command Link’. One of the commands that is allowed on this link is a ‘Resend’ command. This interrupts the server from sending new data over the link. Instead it transmits the packets requested in the resend command packet.

The protocol uses a simple packet structure to encapsulate the data. The packet header contains critical information about each packet. This includes:
Sequence Number: Each packet is uniquely identified by a 32-bit sequence number
Timestamp: Packets can be accompanied by a timestamp which describes when the data in the packet should be decoded or presented
Clock Reference: Inserted by the server, used by the client to reconstruct the system clock
Data Type: Audio, Video (including I, P or B Frame)
   Server

The server is run at start-up as a daemon process. This server process initialises the ‘Listening Socket’ and waits for clients to connect to it. This is a standard TCP socket such that incoming connections can be received and then accepted and bound, such that other clients can still connect to the main listening socket. Once a client has connected, then a new process, a sender process, is forked off from the server process.

Sender Process

The newly created sender process then waits for an ‘Initialisation’ command from the client. This includes a lot of important information, including the identifier of the data required and the address/port of the data sockets that have been created on the client unit. This information is parsed and stored in a local data structure.

The sender process then creates the UDP sockets for the connection (the TCP sockets are inherited from the server process). Two are created as they have different TOS settings. The streaming socket is set as TOS_THROUGHPUT—to maximise bandwidth and throughput. The resend socket is set as TOS_LOWDELAY—to minimise the delay in sending this data.

The sender then initialises a circular packet store. This is used to keep a number of packets that have already been sent. At this point, the system then enters the main protocol state machine.

Sender State Machine

Whilst there is data to send, the sender process loops around inside a state machine. A simplified representation of this machine is shown in FIG. 5.

As can be seen from FIG. 5, data is received from the data source, this data is inserted into the circular buffer, and this data is then sent to the client. This process is interrupted by commands arriving from the client, especially if the client is requesting data be resent. In this case this data is given priority and is sent to the client using the low-delay socket.

This representation is simplified in a number of ways, as explained hereinbelow.

Client Process

The architecture and operation of the client process tend to be simpler than the server architecture it is only deadline with a single stream and so it consists of only one process.

At start-up, the client creates a socket and attempts to connect to the server. Once connected, it then creates the UDP socket on which data will be received. It then builds and sends a “Initialise” command containing the port number of the UDP socket, which data stream is required, and any other options to server.

Then, the client state machine (FIG. 6) receives the data on the input socket (see FIG. 6). Each packet is inserted into the local circular buffer, the position in the buffer is determined by the sequence number embedded in the packet header. The circular buffer is then scanned between the last forwarded packet and the latest input packet creating a list of missing packets. This list is then used to build a Resend command, which is sent to the server process, via the command sockets.

If the next packet in the sequence is available, this is forwarded to the output data pipe.

Commands

Commands are special packets that can go from server to client, or client to server. Commands are usually sent on the connected TCP/IP link, although the software is also designed to allow command communication to go across the UDP data link.

Command Packet Structure

The command packet is adaptable, such that it can be used by the different commands, whilst minimising the amount of data transmitted. The basic header consists of:
Command ID;
Generic 32-bit value;
IP address of command's source;
IP port of command's source;
Length of extended data;
Extended data.

The command structure has very few static variables—the majority of information is in command-specific data appended to the end of the structure.

Resend Command

One of the most frequent commands used whilst streaming is the ‘Resend’ command. This is sent by the client to ask the server to resend a number of packets which have not been received. The server will then make sending these packets its highest priority.

The resend command extends the default command structure by appending a variable length structure on the end. This structure contains a run-length encoded listing of the packets that are missing. Therefore the extended data included, additional to the standard command information, is:
Length of bad packet array;
Maximum length of buffer;
Array of bad packets (start packet and run).
   Past Packets Command

The past packets command is sent from the server to the client. It is used when the client requests that a packet be resent, however this packet has already been dropped from the server's circular buffer and therefore cannot be resent. It is not frequently used, but is important after a bad drop-out of the radio link.

The past packets command lists the packets that have been requested that cannot be resent.

Initialise/Start Command

At start-up, a number of important variables and options are sent from the client to the server. This is done via a start command.

The start command includes:
IP address of client device;
A number of settings of binary options;
Length of data packets;
Filename of required data: this can either be a file on disk, or a ‘special file’ that represents a real-time data source.
   Packet Prioritisation

When a resend command is sent from the client to the server, the server builds and maintains a list of the packets that need to be resent. Additional information about the contents of these packets is used to prioritise them. For example, audio packets are given a higher priority than video, so that there are no glitches in the transmitted audio. Similarly, the transcoder provides information about the video stream. This information is used to prioritise the data such that packets containing data from an I frame have priority over P frames, which, in turn, have priority over B frames.

The priority of a packet is calculated by a simple formula. Four different types of packet are defined: one for audio and three for video (these contain 1, P or B frames). Each packet type has a weight defined for it (Wa, Wi, Wp, Wb respectively). These weights are multiplied by the ‘age’ of a packet, this is calculated by subtracting the sequence number of the missing packet from the sequence number of the most recent packet that has been received correctly (which will be greater than any missing packet).
P=Wx(S−s),
where P is the priority, W the weight of the specific packet type, S the sequence number of the most recently received packet and s the sequence number of the missing packet.

Thus this priority factor is used such that the higher the value of P, the higher the priority given to the packet.

Once the priority of all missing packets has been calculated, this is sorted into a table of missing packets in the order they are to be sent.

Delayed Resend Commands

Thus client creates a list of missed packets each time a new packet is received. To avoid the risk of a large amount of back traffic from the client to the server, requesting the same packet(s) (due to the latency of the round-trip of the resend command) the system operates in one of the following two ways:
1. Each new packet received increments a ‘resend timer’. A packet is only requested on certain intervals of this timer (the period of this is called the resend timeout period). For example, in a system with a resend timeout of 16 packets, it might be determined that packet X is missing after receiving packet Y. Requesting this packet is repeated when we receive packet Y+16, Y+32 etc. until the packet is received correctly.
To avoid a deadlock, the resend timer is also incremented after a period of receiving no packets.
2. The system is set such that resend commands are only sent on a certain interval of the resend timer. Hence, resend commands are calculated and sent for every N packets that are received. This is called the ‘delayedNack’ method.

The first resend operation can lead to a large number of small resend commands being sent. The second resend operating may lead to a higher average latency in sending resend commands.

The software defaults to the first resend operation.

Heartbeat

In order to avoid a situation in which the system could not detect if a client was switched off or died, but the server would keep transmitting and would receive no resend messages back from the client, provision is made for another packet type to the network, namely a ‘heartbeat’ that is sent from the client to the server at regular intervals. If the server does not note the heartbeat for a reasonable length of time, then it assumes the client has died and resets the link so that the client can reconnect.

The heartbeat is sent using UDP sockets. Inside the heartbeat packet some simple statistics are packaged about the client's view of the link which are reported to the server.

Pull Mode

It has been assumed that the data being sent over the link is generated in real-time by the transrater module. In this mode, data is taken out of the transrater as fast as possible and transmitted over the link. This is a typical ‘push’ mode system—in which the decoder keeps up with all data transmitted.

In a variant, a user may want to read from a file, transmit this and then let a decoder work on it. In this mode, the data requirements are dictated by the decoder, as this processes the data at its own rate. This is a typical ‘pull’ mode.

The protocol implements a simple pull-mode system by allowing the client to send pause and resume messages to the server. This works thus:
The server starts sending packets to the client;
The client starts receiving packets and forwarding these into the decoder;
The client detects that the number of packets waiting is greater than a certain value, the high-level watermark. The client sends a pause message to the server;
The server stops sending packets;
The client continues to forward packets to the decoder;
The client detects that the number of packets waiting is less than a certain value, the “low-level watermark”. The client sends a resume message to the server;
The server starts sending packets again.
   Clock Handling

In order to keep audio and video synchronised on the client, it is necessary to generate a stable clock signal. However, due to the indeterminate nature of the wireless network linking the client unit and the server unit, it is very hard to lock the client's clock to the server's.

The higher-level protocol handler, not the base-level protocol, handles clock handling or regeneration as it makes it easier to change the clock handling code. The protocol does, however, reserve space in the packet header for two items of clock information. These are the timestamp for the packet and a clock reference on the server at the point the packet is inserted into the queue.

In the system, the clock handling is done in the TSSA source and sink components (‘ToMips’ and ‘FromMips’).

ToMips

The ToMips component reads the timestamp out of the TSSA packet headers as it receives and repackages the packets. It reduces these timestamps to a 32-bit value and places them in the reserved timestamp field in the Atlantic packet header. Also, as it forwards each packet, it reads the system clock and inserts this value into the packet header.

To ensure that old data is not sent over the wireless link, using up valuable bandwidth, the TSSA packets are filtered as they arrive in the ToMips component. This simply compares the timestamp of the packet with the current clock value, if the timestamp is past a certain threshold older than the current clock, the packet is dropped and not forwarded.

FromMips

The FromMips component reconstructs TSSA packets out of packets. This includes the timestamp information in the packet header.

To reconstruct the clock on the client, the client's clock free-runs, being set by the first packet arriving and when the difference between the client's clock and the clock reference in a packet is greater than one second. This relies on the two systems clock running at the same rate, this providing an accuracy within a few parts in a million.

A variant to the above system may be to implement the protocol at a lower level—the closer this gets to the MAC level the less jitter on the receiveing clock, thereby driving the clients clock.

Packet Header

The packet header consists of:

| Type | Name | Description |
|---|---|---|
| u32 | Sequence Number | A 32-bit sequence number. Used to spot out |
| | | of order and missing packets. This is one |
| | | difference from RTP header, which only has |
| | | a 16-bit sequence number. |
| u32 | Packet Timecode | DTS of the data contained in current packet. |
| | | If zero, this is equal to the last non-zero DTS |
| | | value. |
| u32 | Time Reference | Current value of 90 kHz clock on server. |
| u8 | Data Type | Type of data. Currently only audio and video |
| | | defined. (Video = 0, Audio = 1) |
| u8 | Frame Sequence | If the source is parsing the data to discover |
| | Number (Somewhat | frame types, this also keeps count of frames. |
| | deprecated) | This can be used to spot new frames, or to |
| | | recreate timestamps on the client, if |
| | | required. |
| u16 | Len | Current packet length |
| u16 | Flags | A number of flags, describing the data in the |
| | | packet. Some of these are transmitted |
| | | across the link (e.g. frame type), others are |
| | | used internally in the protocol state |
| | | machines |
| u16 | Picture Start | This used to be used to point to the MPEG |
| | (Deprecated) | picture start (i.e. after Sequence, GOP |
| | | headers etc.). |

The length of the current header is 20 bytes. If required this could be reduced to 16 bytes.

Command Header

| Type | Name | Description |
|---|---|---|
| u32 | Command | The type of command. Possible values are: |

```
0. Null (No command, for test only)
1. Start (Start streaming)
2. Pause (stops server from sending
    non-resend packets)
3. Unpause (allows server to send non-
    resend packets)
4. Resend request
5. End stream (tells client to expect the
    end of stream at a particular
    sequence number)
6. Restart (deprecated - restart sending
    from a particular sequence number)
7. Past packets (allows the server to list
    a number of packets that are no
    longer available).
8. Exit (immediate exit requested).
```

| | | |
|---|---|---|
| u32 | Value | A generic 32-bit number, which is command |
| | | dependant |
| u32 | Client IP | IP address of the client device |
| u16 | Client Port | Data port of client device |
| u16 | Extended Data | Length of data on the end of this command |
| | Length | packet |

1. A method for streaming of data with a limited bandwidth communications network, the method comprising:
reducing the bit rate stream using transrater means (3);
prioritising missing data packets for re-sending according to content format and/or age;
re-sending the data packets according to the prioritisation.

2. A method according to claim 1 wherein the prioritisation step includes defining the data packets according to content type, comprising audio data packets and video data packets.

3. A method according to claim 1 or 2 wherein the prioritisation step includes defining three video types comprising I-frames, P-frames, and B-frames.

4. A method according to any preceding claim wherein the prioritisation step includes defining, for each data packet type, a weighting factor.

5. A method according to claim 4, wherein the weighting factor is multiplied by the “age” factor of a data packet, calculated by subtracting the sequence number of the missing packet from the sequence number of the most recent correctly received data packet such that
P=Wx(S−s),
where P is the priority, Wx, is the weighting factor of the data packet type, S is the sequence number of the most recent correctly received packet and s is the sequence number of the missing data packet.

6. A method according to claim 4 or 5 wherein the weighting factor W for the types of data packet are, in reducing order of importance:
(i) audio;
(ii) I-frames;
(iii) P-frames;
(iv) B-frames.

7. A method according to claim 6 comprising re-sending the data packets with the highest value of P first and thereafter re-sending in sequence according to reducing values of P, with the lowest value of P being last.

8. A method according to any preceding claim comprising incrementing a resend timer when a new data packet is received, and requesting a data packet at certain intervals of the timer.

9. A method according to claim 8 further comprising incrementing the resend timer after a period of receiving no data packets.

10. A method according to any of claims 1 to 7 comprising transmitting resend commands only on a certain interval of the resend timer.

11. A method according to any preceding claim wherein the limited bandwidth communications network comprises a wireless network.

12. A computer program product directly loadable into the internal memory of a digital computer, comprising software code portions for performing the steps of any one or more of claims 1 to 11 when said product is run on a computer.

13. A computer program for performing the steps of any one or more of claims 1 to 11 when said product is run on a computer.

14. Electronic distribution of a computer program product according to claim 12 or a computer according to claim 13.

15. A system (1) for streaming of data with a limited bandwidth communications network, the system comprising:
transrater means (3);
means (2) to input data packets to the transrater means to reduce the bit rate stream;
means (3) to prioritise missing data packets for re-sending according to content format and/or age;
means (6) to re-send the missing data packets according to the prioritisation.

16. A system according to claim 15 wherein the prioritisation means (3) includes means to define the data packets according to content type, comprising audio data and video data packets.

17. A system according to claim 15 or 16 wherein the prioritisation means (3) includes means to define three video types comprising I-frames, P-frames, and B-frames.

18. A system according to any of claims 15 to 17 wherein the prioritisation means (3) includes means to define, for each data packet type, a weighting factor.

19. A system according to claim 18, wherein the weighting factor is multiplied by the “age” factor of a data packet, calculated by subtracting the sequence number of the missing packet from the sequence number of the most recent correctly received data packet such that
P=Wx(S−s),
where P is the priority, Wx, is the weighting factor of the data packet type, S is the sequence number of the most recent correctly received packet and s is the sequence number of the missing data packet.

20. A system according to claim 18 or 19 wherein the weighting factor W for the types of data packet are, in reducing order of importance:
(i) audio;
(ii) I-frames;
(iii) P-frames;
(iv) B-frames.

21. A system according to claim 20 comprising means (6) to re-send the data packets with the highest value of P first and thereafter in sequence according to reducing values of P, with the lowest value of P being last.

22. A system according to any of claims 15 to 21 comprising means to increment a resend timer when a new data packet is received, and requesting a data packet at certain intervals of the timer.

23. A system according to claim 22 further comprising means to increment the resend timer after a period of receiving no data packets.

24. A system according to any of claims 15 to 23 comprising means (6) to transmit resend commands only on a certain interval of the resend timer.

25. A system according to any of claims 15 to 24 wherein the limited bandwidth communications network comprises a wireless network.

26. Apparatus for streaming of data with a limited bandwidth communications network, the apparatus comprising:
transrater means (3);
means (2) to input data packets to the transrater means to reduce the bit rate stream;
means (3) to prioritise missing data packets for re-sending according to content format and/or age;
means (6) to re-send the missing data packets according to the prioritisation.

27. Apparatus according to claim 24 wherein the prioritisation means includes one or more of the following:
means to define the data packets according to content type, comprising audio data and video data packets;
means to define three video types comprising I-frames, P-frames, and B-frames;
means includes means to define, for each data packet type, a weighting factor.

28. Apparatus according to claim 25, wherein the weighting factor is multiplied by the “age” factor of a data packet, calculated by subtracting the sequence number of the missing packet from the sequence number of the most recent correctly received data packet such that
P=Wx(S−s),
where P is the priority, Wx, is the weighting factor of the data packet type, S is the sequence number of the most recent correctly received packet and s is the sequence number of the missing data packet.

29. Apparatus according to claim 25 or 26 wherein the weighting factor W for the types of data packet are, in reducing order of importance:
(i) audio;
(ii) I-frames;
(iii) P-frames;
(iv) B-frames.

30. Apparatus according to claim 27 comprising means to re-send the data packets with the highest value of P first and thereafter in sequence according to reducing values of P, with the lowest value of P being last.
